(19) United States
(12) Patent Application Publication
(10) Pub. No.: US 2025/0383579 A1
(43) Pub. Date: Dec. 18, 2025

(54) Broadband Light Generator and Broadband Light Generating Method Thereof

(71) Applicant: BRIGHTEST TECHNOLOGY TAIWAN CO., LTD., Hsinchu County (TW)

(72) Inventors: Heng-Jia Liu, Hsinchu County (TW); Pei-Chi Huang, Hsinchu County (TW); Te Lo, Hsinchu County (TW); Shih-Cheng Liu, Hsinchu County (TW)

(73) Assignee: BRIGHTEST TECHNOLOGY TAIWAN CO., LTD., Hsinchu County (TW)

(21) Appl. No.: 18/741,825

(22) Filed: Jun. 13, 2024

(51) Int. Cl. G02F 1/35

(52) U.S. Cl. CPC G02F 1/3528; G02F 1/3503; G02F 1/3505

(57) ABSTRACT

A broadband light generator includes a light source configured to emit light, and a spectral broadening device optically coupled to the light source. A nonlinear refractive index distribution of non-solid substance within the spectral broadening device is uneven along an optical path. The unevenness allows manipulation of the location where spectral broadening occurs, thereby optimizing beam quality.

### BACKGROUND OF THE INVENTION

### 1. Field of the Invention

The present invention relates to a broadband light generator and a broadband light generating method thereof, and more particularly, to a broadband light generator and a broadband light generating method thereof that improve beam quality.

### 2. Description of the Prior Art

It is generally known that optical semiconductor metrology, material inspection, or medical biotechnology rely on broadband light sources. Spectral broadening for emitting broadband radiation is achieved through Kerr effect, wherein the refractive index n(I) of a medium correlates with the intensity I of a light pulse (e.g., n(I)=n₀+n₂I, where no represents the linear refractive index of the medium, and n₂(or n₄, n₆, . . . ) represents the nonlinear refractive index of the medium). Through self-phase modulation (SPM), the variation Δn(I) in refractive index n(I) induces a shift in the instantaneous phase of the light pulse, and the phase shift results in a frequency shift of the light pulse. Accordingly, the spectrum of the light pulse is broadened during propagation in the medium.

Although using gas as the medium has significant advantage over solid in terms of lifetime performance, the degradation in beam quality is more pronounced in the absence of gas distribution control. To optimize beam quality, there is room for further improvement when it comes to gas medium spectral broadening.

### SUMMARY OF THE INVENTION

It is therefore a primary objective of the present application to provide a broadband light generator and a broadband light generating method thereof, to improve over disadvantages of the prior art.

An embodiment of the present invention discloses a broadband light generator comprising a light source, configured to emit light; and a spectral broadening device, optically coupled to the light source, wherein a nonlinear refractive index distribution of non-solid substance within the spectral broadening device is uneven along an optical path.

An embodiment of the present invention discloses a broadband light generating method comprising emitting light; and directing the light into a spectral broadening device, wherein a nonlinear refractive index distribution of non-solid substance within the spectral broadening device is uneven along an optical path.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 7 are schematic diagrams of cross-section views of broadband light generators according to embodiments of the present invention.

FIG. 8 and FIG. 9 are schematic diagrams of simulation results according to embodiments of the present invention.

### DETAILED DESCRIPTION

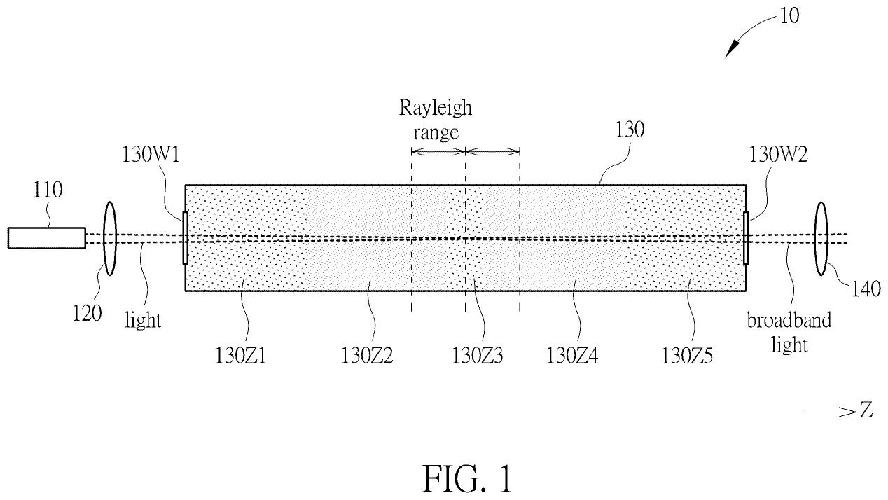

FIG. 1 is a schematic diagram of a cross-section view of a broadband light generator 10 according to an embodiment of the present invention. The broadband light generator comprises a light source 110, a focusing component 120, a spectral broadening device 130, and a re-collimation component 140, which are optically coupled in sequence.

The light source 110 is configured to emit light (e.g., a sequence of light pulses or a beam of light). The light source 110 may be any radiation source (e.g., laser). The emitted radiation from the light source 110 may comprise any type of electromagnetic radiation (e.g., infrared (IR) radiation, near infrared (NIR) radiation, ultraviolet (UV) radiation, or their combinations).

The focusing component 120 may focus the light into the spectral broadening device 130 or pinpoint the Rayleigh range. The focusing component 120 is made of glass with optical quality (e.g., a lens) or other material(s) of high transmittance. In an embodiment, the focusing component 120 may be disposed either between windows 130W1 and 130W2 of the spectral broadening device 130, or between the light source 110 and the window 130W1. In an embodiment, the focusing component 120 may be disposed a zone (e.g., 130Z1) of low nonlinear refractive index.

The spectral broadening device 130 is configured to spectrally broaden the light. Within the spectral broadening device 130, the light propagates along an optical path, experiences spectral broadening, and is converted into broadband light. For example, the light initially emitted from the light source 110 has a wavelength in the range of about 1025-1035 nm, while the broadband light exiting the spectral broadening device 130 has a wavelength in the range of about 990-1100 nm. In other words, the spectrum of the light is broadened.

The degree of spectral broadening depends on the variation Δn(I) in refractive index n(I), in terms of a points along the optical path. Specifically, elongating the distance(s) of zone(s) (e.g., 130Z2 or 130Z4) of high nonlinear refractive index, increasing the nonlinear refractive index in the zone(s), or boosting light intensity can enhance the degree of spectral broadening across the entire optical path. In other words, a higher nonlinear refractive index or greater light intensity results in a larger variation Δn(I) in refractive index n(I), thus inducing a more pronounced SPM frequency shift. Since light intensity around/within the Rayleigh range is high, non-solid substance of higher nonlinear refractive index may be strategically disposed within the Rayleigh range (e.g., within the zone 130Z2 or 130Z4) to maximize the variation Δn(I) in refractive index n(I) or frequency shift.

To ensure beam quality, spectral broadening is induced and confined within specific zone(s) of the spectral broadening device 130. Specifically, as the light transitions from the near field to the far field, significant changes occur in beam cross-section, particularly during focusing. The nonlinear effect in the zone (e.g., 130Z1 or 130Z5) away from the Rayleigh range, in spite of resulting in frequency shift, continuously generates spectral components at different points along the optical path, leading to spatial randomness or irregularities and impacting the beam quality (e.g., the beam cross-section). Therefore, it is advantageous to localize non-solid substance of higher nonlinear refractive index mainly around/within the Rayleigh range (e.g., within the zone 130Z2 or 130Z4), such that the broadband light may be created mainly near/around the Rayleigh range within the spectral broadening device 130. With the nonlinear effect range control of the spectral broadening device 130, enhancements in beam quality can be achieved.

To optimize throughput lifetime, the spectral broadening device 130 accommodates non-solid substance. The term “non-solid substance” inherently implies it is gaseous or liquid, and, for example, may comprise a gas, a gas mixture, a liquid, a liquid mixture, or a combination thereof. In an embodiment, a gas may be a kind of monatomic gas (e.g., a noble gas) or a kind of gas with (spherical) symmetrical molecular structure (e.g., Sulfur Hexafluoride (SF₆) or, Methane (CH₄)), which may limit nonlinear effect to self-phase modulation. Solid crystal damage causes noticeable long-term throughput decay and reduces output power stability. Compare to solid, which is susceptible to damage from light exposure, non-solid substance offers an advantage in enhancing throughput lifetime.

To avoid nonlinear effect from occurring within solid material(s), the spectral broadening device 130 is longer than the Rayleigh range, such that solid material(s) can be located away from the Rayleigh range or near the place where the beam width is large. For example, the spectral broadening device 130 may comprise the windows 130W1 and 130W2 located at respective ends of the spectral broadening device 130. The windows 130W1 and 130W2, which are configured to seal the spectral broadening device 130 (e.g., a vacuum compatible chamber) and allow light transmission, are solid. For example, the window 130W1 or 130W2 is made of glass with optical quality (e.g., a flat lens) or other material(s) of high transmittance, or coated with low reflectivity material(s). To prevent the onset of nonlinear effect within the windows 130W1 and 130W2, the windows 130W1 and 130W2 are placed away from the Rayleigh range or outside the focusing range of the focusing component 120, such that the windows 130W1 and 130W2 may not contribute to any B-integral. Between the window (e.g., 130W1 or 130W2) and the Rayleigh range (e.g., in the zone 130Z1 or 130Z5), there may be non-solid substance of lower nonlinear refractive index or a vacuum, to mitigate undesired nonlinear effect.

To avoid plasma or ionization, the nonlinear refractive index of non-solid substance is low near the focal point of the focusing component 120. At the focal point, the beam width is the smallest, while light intensity is at its peak. The intense light near the focal point may cause plasma or ionization of the non-solid substance. Since plasma or ionization is undesired, the non-solid substance near the focal point (e.g., in zone 130Z3) is designed with a lower nonlinear refractive index, resulting in weaker spectral broadening effect.

In another aspect, the nonlinear refractive index distribution of non-solid substance within the spectral broadening device 130 is uneven along the optical path (e.g., the z-axis). The term “uneven” inherently implies nonlinear refractive indices are unequal or different in position, arrangement, or frequency of occurrence throughout the spectral broadening device 130. The increase in nonlinear refractive index can be achieved, for example, by raising pressure, increasing the number of moles or density, utilizing certain type of non-solid substance, or reducing temperature. Confining non-solid substance of higher nonlinear refractive index to certain spectral broadening effective range(s) (e.g., the zone 130Z2 or 130Z4), introducing non-solid substance of lower nonlinear refractive index between the window (e.g., 130W1 or 130W2) and the Rayleigh range (e.g., in the zone 130Z1 or 130Z5), or reducing nonlinear refractive index near the focal point of the focusing component 120 (e.g., in the zone 130Z3) may lead to the unevenness of the nonlinear refractive index distribution.

There are ways to achieve the unevenness of the nonlinear refractive index distribution. Specifically, a chamber of the spectral broadening device 130 may be classified into the zones 130Z1 to 130Z5, each housing one or more kinds of gas/liquid. In an embodiment, the nonlinear refractive index (e.g., n₂) relies on the type of non-solid substance, and the nonlinear refractive index of a second (kind of) non-solid substance in the zone 130Z2 or 130Z4 may be higher than the nonlinear refractive index of a first (kind of) non-solid substance in the zone 130Z1, 130Z3, or 130Z5, to achieve the unevenness of the nonlinear refractive index distribution. The second non-solid substance is the same as, similar to, or different from the first non-solid substance. For example, the second non-solid substance may be a kind of monatomic gas (e.g., a noble gas) or a kind of gas with (spherical) symmetrical molecular structure (e.g., SF₆ or CH₄); the first non-solid substance may be He, Ne or gas with n2 lower than air. In an embodiment, the nonlinear refractive index is a function of the number of moles, the concentration, or the density of non-solid substance, and the number of moles of the second non-solid substance in the zone 130Z2 or 130Z4 may be higher than (or equal to) the number of moles of the first non-solid substance in the zone 130Z1, 130Z3, or 130Z5, to achieve the unevenness of the nonlinear refractive index distribution. In an embodiment, the nonlinear refractive index is a function of pressure, and the pressure in the zone 130Z2 or 130Z4 may be higher than (or equal to) the pressure in the zone 130Z1, 130Z3, or 130Z5, to achieve the unevenness of the nonlinear refractive index distribution.

Different zones (e.g., 130Z1-130Z5) may be of different sizes. The zone 130Z2 or 130Z4, which represents a spectral broadening effective range, may cover the Rayleigh range, for example, to maximize the variation Δn(I) in refractive index n(I). For example, the total length of the zones from 130Z2 to 130Z4 (along the optical path for spectral broadening) is more than twice the Rayleigh range or less than ten times the Rayleigh range. The zone 130Z3, which is disposed between the zones 130Z2 and 130Z4, is a smaller area. For example, the length of the zone 130Z3 (along the optical path) is less than twice the Rayleigh range. The length of the zone 130Z2 may be the same as, similar to, or different from the length of the zone 130Z4. The length of the zone 130Z1 (or 130Z5) (along the optical path) may be longer than, shorter than, the same as, or similar to the length of the zone 130Z2 (or 130Z4). It's noted that a confocal parameter is twice the Rayleigh range.

The structure of the spectral broadening device 130 facilitates alignment and installation. The spectral broadening device 130 may be cylindrical or cuboid in shape. The spectral broadening device 130 may possess symmetry with respect to a symmetrical axis (e.g., the optical path) or at least one symmetrical plane (e.g., the cross-section shown in FIG. 1). The spectral broadening device 130 may be one-piece design.

Noted that, optical fibers or waveguides are absent from the spectral broadening device 130. The spectral broadening device 130 is neither an optical fiber nor a waveguide, and the cross section of the spectral broadening device 130 exceeds the diameter of a typical optical fiber or a typical waveguide. Accordingly, there is no need to couple the light into an optical fiber or a waveguide, thereby avoiding potential issues related to optical fiber or waveguide coupling or improving beam pointing tolerance.

The re-collimation component 140 serves to collimate the broadband light. The re-collimation component 140 is made of glass with optical quality (e.g., a lens) or other material(s) of high transmittance. In an embodiment, the re-collimation component 140 may be disposed inside/outside the spectral broadening device 130 (e.g., between the windows 130W1 and 130W2 or between the window 130W2 and an additional device like a grating pair). In an embodiment, the re-collimation component 140 may be disposed a zone (e.g., 130Z5) of low nonlinear refractive index. The optical axis of the focusing component 120 may be aligned to the optical axis of the re-collimation component 140 or the optical axis of the spectral broadening device 130.

As set forth above, to optimize spectrum broadening effect, the present invention chooses suitable nonlinear material(s) to serve as the non-solid substance(s), which possess the desired nonlinear refractive index/indices and higher damage threshold. Besides, the light emitted from the light source 110 converges with the help of the focusing component 120. Moreover, the nonlinear effective range is controlled, and the non-solid substance(s) of high nonlinear refractive index/indices is/are distributed only near/in the Rayleigh range.

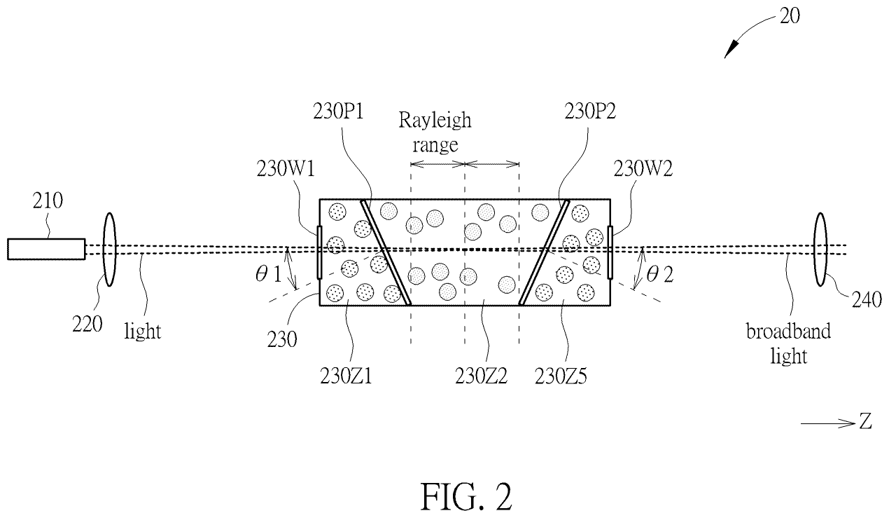

In addition, the present invention incorporates mechanisms to control the non-solid substance distribution and determine the zone(s) where spectral broadening occurs. For example, FIG. 2 is a schematic diagram of a cross-section view of a broadband light generator 20 according to an embodiment of the present invention. The broadband light generator 20 comprises a light source 210, a focusing component 220, a spectral broadening device 230, and a re-collimation component 240.

The spectral broadening device 230 is partitioned into three sub-chambers corresponding to zones 230Z1, 230Z2, and 230Z5, respectively. The zones 230Z1, 230Z2, and 230Z5 may be implemented using the zones 130Z1, 130Z2, and 130Z5. For example, the first sub-chamber in the zone 230Z1 may hold a first (kind of) non-solid substance (e.g., a first kind of gas). The second sub-chamber in the zone 230Z2 may hold a second (kind of) non-solid substance (e.g., a second kind of gas). The third sub-chamber in the zone 230Z5 may hold a third (kind of) non-solid substance (e.g., the first kind of gas). The first non-solid substance is the same as, similar to, or different from the second or third non-solid substance. The three sub-chambers are not optical fibers or waveguides, thereby avoiding optical fiber or waveguide coupling issues or improving beam pointing tolerance.

The nonlinear refractive index distribution of non-solid substance within the spectral broadening device 230 is uneven along the optical path. The nonlinear refractive index of the second non-solid substance in the zone 230Z2 may be higher than the nonlinear refractive index of the first or third non-solid substance in the zone 230Z1 or 230Z5. The nonlinear refractive index of the first non-solid substance in the zone 230Z1 may be the same as or similar to the nonlinear refractive index of the third non-solid substance in the zone 230Z5.

The spectral broadening device 230 is longer than the Rayleigh range, such that certain solid material(s) can be located as far away from the Rayleigh range as possible. Specifically, the spectral broadening device 230 comprises plates 230P1, 230P2, and windows 230W1, 230W2, delineating a portion of the boundaries of the zones 230Z1, 230Z2, and 230Z5. The windows 230W1 and 230W2, which are solid, are placed away from the Rayleigh range, such that the windows 230W1 and 230W2 may not contribute to any B-integral. Between the window (e.g., 230W1 or 230W2) and the plate (e.g., 230P1 or 230P2), the zone 230Z1 or 230Z2 accommodates non-solid substance of lower nonlinear refractive index, to mitigate undesired nonlinear effect.

Spectral broadening is induced and confined within the zone 230Z2 of higher nonlinear refractive index to improve beam quality. Specifically, if spectral broadening effect occurs all over the optical path (rather than just near the Rayleigh range), the beam quality imperfection of a light pulse worsens. The zone 230Z2, representing a spectral broadening effective range, covers the Rayleigh range, to localize spectral broadening. The length of the zone 230Z2, for example, is more than twice the Rayleigh range or less than ten times the Rayleigh range.

The plates 230P1 and 230P2 are located at the boundary of the zone 230Z2. The plate 230P1 or 230P2 is used as separators, to isolate the non-solid substance in one zone from another. In another aspect, the plates 230P1, 230P2 confine the range or position where spectral broadening effect happens (e.g., in the zone 230Z2). Since the plate 230P1 or 230P2 may not be far from the Rayleigh range, the plates 230P1, 230P2 may contribute to the spectral broadening effect, thereby reducing the required pressure and the required length for the non-solid substance of high nonlinear refractive index while keeping the same B-integral number.

As light intensity increases, reflectivity becomes a more critical issue. To reduce reflectivity, for example, the plate 230P1, 230P2 or the window 230W1, 230W2 is made of glass with optical quality (e.g., a flat lens) or other material(s) of high transmittance, or coated with low reflectivity material(s) that can withstand high light intensity. In an embodiment, the window 230W1 or 230W2 may be oriented substantially perpendicular to the optical path because of larger beam width. In an embodiment, there may be an angle 01 between (the normal of) the plate 230P1 and the optical path (or an angle θ1 between the plate 230P1 and the window 230W1); there may be an angle θ2 between (the normal of) the plate 230P2 and the optical path (or an angle θ2 between the plate 230P2 and the window 230W2). The plates 230P1 and 230P2 may be parallel/un-parallel to each other, or symmetric to each other with respect to a plane parallel to the window 230W1 or 230W2. The angle θ1 (or θ2) may be a function of the nonlinear refractive index of the non-solid substance in the zone 230Z1 (or 230Z5) and the nonlinear refractive index of the non-solid substance in the zone 230Z2. For example, the angle θ1 or θ2 may be Brewster's angle, to reduce reflectivity and increase transmittance. In terms of the linear polarized incident light with its electric vector parallel to the plane of incident, there may be no reflected light, and the transmittance may be unity.

The plate 230P1 or 230P2 may be thin, necessitating pressure control. Different pressures in adjacent sub-chambers can exert forces on the plate 230P1 or 230P2 (e.g., a thin film, a film, or a membrane), potentially causing the plate 230P1 or 230P2 to bend and degrade beam quality. To mitigate this issue, pressures on opposite sides of the plate 230P1 or 230P2 should be balanced. For example, the pressure of the non-solid substance of high nonlinear refractive index (e.g., in the zone 230Z2) is determined according to the predetermined broaden bandwidth, and the pressure of the non-solid substance of low nonlinear refractive index (e.g., in the zone 230Z1 or 230Z5) is adjusted to match the pressure corresponding to the high nonlinear refractive index (e.g., in the zone 230Z2), thereby minimizing the force exerted on plate 230P1 or 230P2. In other words, the pressure in the three sub-chambers may be all the same (e.g., greater than 1 atm or the pressure outside the spectral broadening device 230).

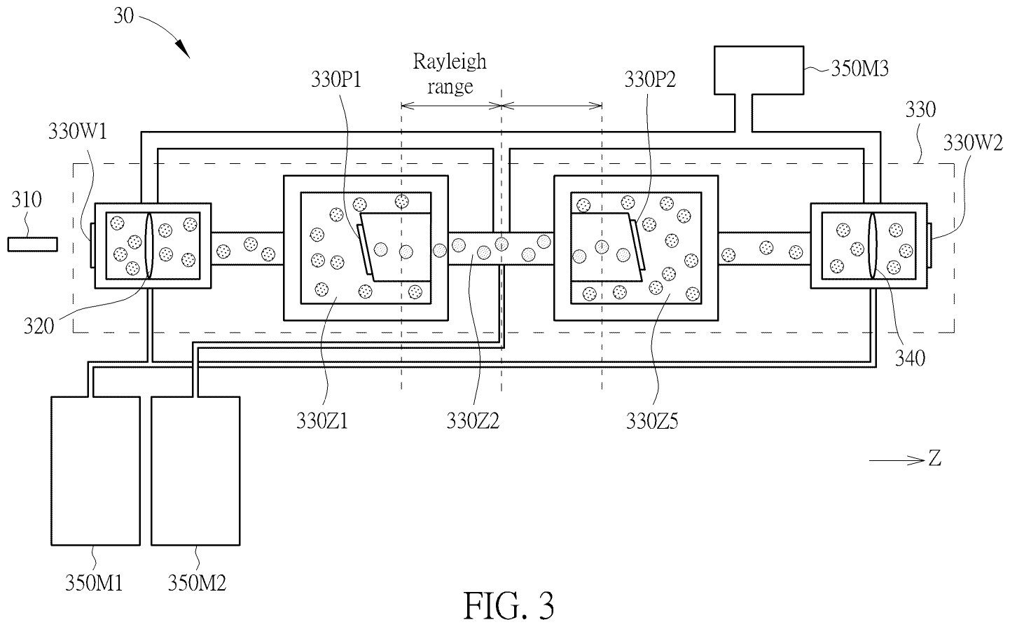

FIG. 3 is a schematic diagram of a cross-section view of a broadband light generator 30 according to an embodiment of the present invention. The broadband light generator 10 or 20 may be implemented using the broadband light generator 30, which comprises a light source 310, a focusing component 320, a spectral broadening device 330, a re-collimation component 340, and non-solid substance movers 350M1 to 350M3.

The spectral broadening device 330 is divided into zones 330Z1, 330Z2, and 330Z5. Two cavities and a tube (e.g., a KF25-flanged component) connecting the two cavities constitute a first sub-chamber in the zone 330Z1, whose boundary is defined at least by a window 330W1 and a plate 330P1. Two cavities and a tube constitute a second sub-chamber in the zone 330Z2, whose boundary is defined at least by plates 330P1 and 330P2. Two cavities and a tube constitute a second sub-chamber in the zone 330Z5, whose boundary is defined at least by window 330W2 and the plate 330P2. The size/diameter of the plates 330P1 or 330P2 is larger than or equal to the size/diameter of the window 330W1 or 330W2, or comparable to the size/diameter of the focusing component 320 or the re-collimation component 340. Neither the cavities nor the tubes are optical fibers or waveguides, thereby avoiding optical fiber or waveguide coupling issues or improving beam pointing tolerance.

The nonlinear refractive index distribution of non-solid substance within the spectral broadening device 330 is uneven along the optical path. The first or third sub-chamber may be communicated with the non-solid substance mover 350M1 (e.g., a gas tank or a gas source), which supplies/pumps non-solid substance of lower nonlinear refractive index into the first or third sub-chamber. The second sub-chamber may be communicated with the non-solid substance mover 350M2 (e.g., a gas tank or a gas source), which supplies/pumps non-solid substance of higher nonlinear refractive index into the second sub-chamber.

The plate 330P1 or 330P2 may be thin, making pressure control necessary. For example, the non-solid substance movers 350M1 and 350M2 may introduce non-solid substances of different nonlinear refractive indices into the first to third sub-chambers under the automatic control of a controller (e.g., a computer or host), via controllable valve(s), or at the user's command, to minimize pressure difference between the opposite sides of the plate 330P1 or 330P2 (e.g., a thin film, a film, or a membrane). Besides, the first to third sub-chambers may be communicated with the non-solid substance mover 350M3 (e.g., a dry pump), which removes/pumps non-solid substances out of the first to third sub-chambers. The non-solid substance mover 350M3 may move non-solid substances out of the first to third sub-chambers concurrently or synchronously under the automatic control of the controller, via controllable valve(s), or at the user's command, such that there is no pressure difference between the opposite sides of the plate 330P1 or 330P2.

The spectral broadening device 330 may leverage the non-solid substance movers 350M1-350M3 to regulate the density or the number of moles in the zones 330Z1, 330Z2, and 330Z5. In another embodiment, one or more of the non-solid substance movers 350M1-350M3 may be omitted as the broadband light generator 20. For commercial use, the non-solid substance movers 350M1-350M3 may not be desired. The first to third sub-chambers of the spectral broadening device 330 may be filled with non-solid substances only during production or before being sealed.

In FIG. 3, the focusing component 320 and the re-collimation component 340 are disposed within the zones 330Z1 and 330Z5 of the spectral broadening device 330, respectively. However, the focusing component 320 and the re-collimation component 340 may be disposed outside the spectral broadening device 330 as the broadband light generator 20.

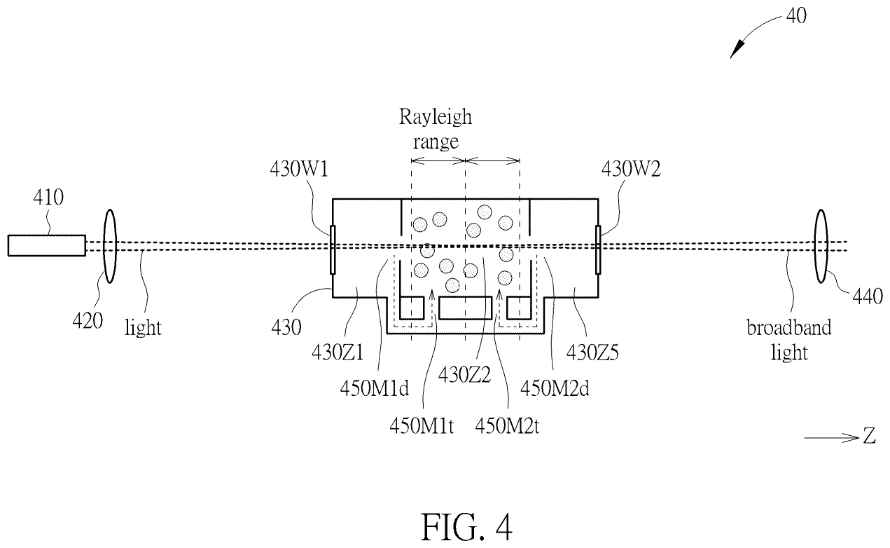

FIG. 4 is a schematic diagram of a cross-section view of a broadband light generator 40 according to an embodiment of the present invention. The broadband light generator 40 comprises a light source 410, a focusing component 420, a spectral broadening device 430, a re-collimation component 440, and non-solid substance movers 450M1t, 450M1d, 450M2t, 450M2d.

The spectral broadening device 430 is divided into zones 430Z1, 430Z2, and 430Z5. The zones 430Z1, 430Z2, and 430Z5 are communicated with each other via opening(s) or channel(s). In FIG. 4, an opening may be located near at the head or the tail of a dashed arrow, and a channel may be located along the path indicated by the dashed arrow. Optical fibers or waveguides are absent from the spectral broadening device 430, thereby avoiding optical fiber or waveguide coupling issues or improving beam pointing tolerance.

The nonlinear refractive index distribution of non-solid substance within the spectral broadening device 430 is uneven along the optical path. For example, the spectral broadening device 430 may accommodate only one non-solid substance (e.g., a gas, a gas mixture, a liquid, a liquid mixture, or a combination thereof), with a pressure distribution that varies with position. For example, the pressure (or the nonlinear refractive index) of the non-solid substance in the zone 430Z2 may be higher than the pressure (or the nonlinear refractive index) of the non-solid substance in the zone 430Z1 or 430Z5. In an embodiment, a vacuum may be created in the zone 430Z1 or 430Z5.

To achieve the unevenness of the nonlinear refractive index distribution, the non-solid substance mover 450M1t, 450M1d, 450M2t, or 450M2d may be used to adjust density distribution or pressure distribution of non-solid substance. For example, the non-solid substance mover 450M1t may move/pump non-solid substance (from the zone 430Z1) into the zone 430Z2. For example, the non-solid substance mover 450M2t may move/pump non-solid substance (from the zone 430Z5) into the zone 430Z2. As a result, the nonlinear refractive index (or the pressure) of the zone 230Z2 is higher, to induce or confine spectral broadening within the zone 230Z2, thereby improving beam quality. For example, the non-solid substance mover 450M1d may move/remove non-solid substance from the zone 430Z1 (into the zone 430Z2). For example, the non-solid substance mover 450M2d may move/remove non-solid substance from the zone 430Z5 (into the zone 430Z2). As a result, the nonlinear refractive index (or the pressure) between a window (e.g., 430W1 or 430W2) and the Rayleigh range is low to mitigate undesired nonlinear effect, and the window (e.g., 430W1 or 430W2) can be placed away from the Rayleigh range.

In another aspect, the non-solid substance movers 450M1t-450M2d result in pressure differentials, and thus create the different zones 430Z1, 430Z2, and 430Z5 inside the spectral broadening device 430. As the pressure in the spectral broadening device 430 is uneven, the nonlinear refractive index distribution of non-solid substance within the spectral broadening device 430 becomes uneven.

To achieve adjustable pressures, a non-solid substance mover may be implemented in various ways. For example, the non-solid substance mover 450M1t or 450M2t may be a gas distribution manipulator, a gas tank, a blower, or a cooler. For example, the non-solid substance mover 450M1d or 450M2d may be a gas distribution manipulator, a pump, a gas pump (e.g., a turbo pump, a dry pump, or a root pump), a blower, or a heater. The non-solid substance mover 450M1t or 450M1d may establish an internal circulation, as indicated by the counterclockwise dashed arrow shown in FIG. 4. The non-solid substance mover 450M2t or 450M2d may establish an internal circulation, as indicated by the clockwise dashed arrow shown in FIG. 4.

The position of a non-solid substance mover may be adjusted according to different consideration. In an embodiment, one or more of the non-solid substance movers 450M1t-450M2d may be disposed within the spectral broadening device 430. In an embodiment, one or more of the non-solid substance mover 450M1t-450M2d may be disposed external to the spectral broadening device 430 as the broadband light generator 30.

The number of non-solid substance movers may be adjusted according to different consideration. In another embodiment, one or more of the non-solid substance movers 450M1t-450M2d (e.g., 450M1t and 450M2t) (e.g., 450M1d and 450M2d) may be omitted.

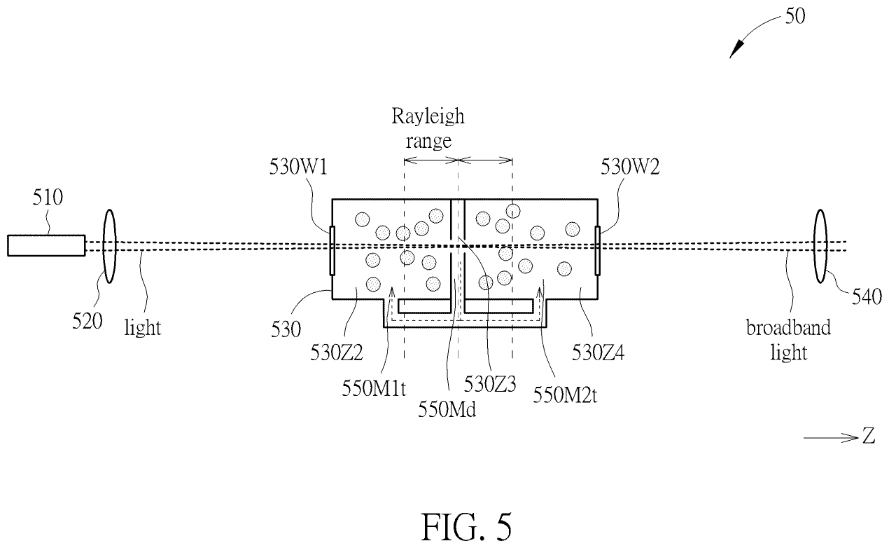

FIG. 5 is a schematic diagram of a cross-section view of a broadband light generator 50 according to an embodiment of the present invention. The broadband light generator 50 comprises a light source 510, a focusing component 520, a spectral broadening device 530, a re-collimation component 540, and non-solid substance movers 550M1t, 550M2t, 550Md.

The spectral broadening device 530 is divided into zones 530Z2 to 530Z4. The zones 530Z2-530Z4 are communicated with each other via opening(s) or channel(s). Optical fibers or waveguides are absent from the spectral broadening device 530, thereby avoiding optical fiber or waveguide coupling issues or improving beam pointing tolerance.

The nonlinear refractive index distribution of non-solid substance within the spectral broadening device 530 is uneven along the optical path. For example, the spectral broadening device 530 may accommodate only one non-solid substance, with a pressure distribution that varies with position. For example, the pressure (or the nonlinear refractive index) of the non-solid substance in the zone 530Z2 or 530Z4 may be higher than the pressure (or the nonlinear refractive index) of the non-solid substance in the zone 530Z3. In an embodiment, a vacuum may be created in the zone 530Z3.

To achieve the unevenness of the nonlinear refractive index distribution, the non-solid substance mover 550M1t, 550M2t, or 550Md may be used to adjust density distribution or pressure distribution of non-solid substance. For example, the non-solid substance mover 550M1t may move/pump non-solid substance (from the zone 530Z3) into the zone 530Z2. For example, the non-solid substance mover 550M2t may move/pump non-solid substance (from the zone 530Z3) into the zone 530Z4. As a result, the nonlinear refractive index (or the pressure) of the zone 530Z2 or 530Z4 is higher, to induce or confine spectral broadening within the zone 530Z2 or 530Z4, thereby improving beam quality. For example, the non-solid substance mover 550Md may move/remove non-solid substance from the zone 530Z3 (into the zone 530Z2 or 530Z4). As a result, the nonlinear refractive index of non-solid substance is low near the focal point of the focusing component 520, to avoid unwilling nonlinear effect from occurring at certain high-intensity spot (e.g., the zone 430Z3), thereby inhibiting the formation of plasma or ionization.

To achieve adjustable pressures, a non-solid substance mover may be implemented in various ways. For example, the non-solid substance mover 550M1t or 550M2t may be a gas distribution manipulator, a gas tank, a blower, or a cooler. For example, the non-solid substance mover 550Md may be a gas distribution manipulator, a pump, a gas pump, a blower, or a heater. The non-solid substance mover 550M1t or 550Md may establish an internal circulation, as indicated by the clockwise dashed arrow shown in FIG. 5. The non-solid substance mover 550M2t or 550Md may establish an internal circulation, as indicated by the counterclockwise dashed arrow shown in FIG. 5.

The position of a non-solid substance mover may be adjusted according to different consideration. In an embodiment, one or more of the non-solid substance movers 550M1t-550Md may be disposed inside or outside the spectral broadening device 530.

The number of non-solid substance movers may be adjusted according to different consideration. In another embodiment, one or more of the non-solid substance movers 550M1t-550Md (e.g., 550M1t and 550M2t) (e.g., 550Md) may be omitted.

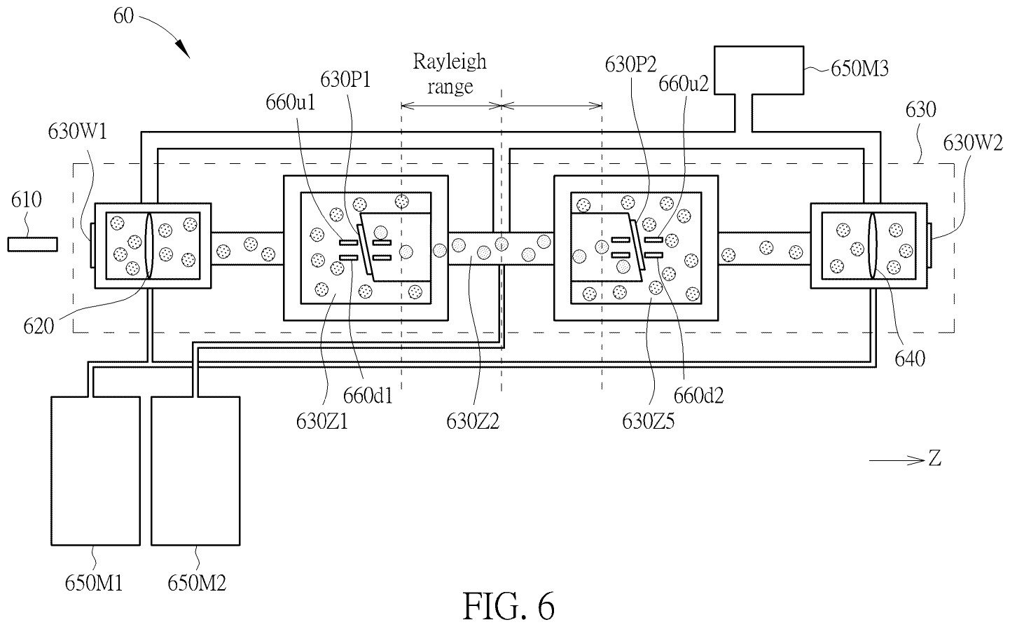

FIG. 6 is a schematic diagram of a cross-section view of a broadband light generator 60 according to an embodiment of the present invention. The broadband light generator 60 comprises a light source 610, a focusing component 620, a spectral broadening device 630, a re-collimation component 640, non-solid substance movers 650M1, 650M2, 650M3, and particle reducers 660u1, 660d1, 660u2, and 660d2.

Particle reduction, which is a physical process that stops small suspended particles and contaminants, may be adopted in the spectral broadening device 630. Specifically, when the light of high intensity strikes a solid material (e.g., plate 630P1 or 630P2), particles of the solid material may detach from its surface and become debris, which suspended in space or stick to surface(s) of other component(s). When the light is incident, the light (e.g., laser) traps the debris carrying electrical charge(s) (along the optical path), causing the debris to contaminate the space (e.g., light scattering) or the surface(s) of other component(s). Therefore, at least one particle reducer (e.g., 660u1 . . . or 660d2) is disposed near the plate 630P1 or 630P2 of the spectral broadening device 630, to achieve particle reduction or particle control.

A particle reducer (e.g., 660u1 . . . or 660d2) may be implemented in various ways. For example, a particle reducer may be a (broad) electrode. The particle reducer 660u1 and 660d1 may be parallel and aligned; the particle reducer 660u2 and 660d2 may be parallel and aligned. Once a charged particle or debris detaches from the surface of the plate 630P1 or 630P2, the charged particle or debris is immediately attracted to and then sticks to one of the opposite particle reducers (e.g., 660u1 or 660d1) (e.g., 660u2 or 660d2), to achieve particle reduction or particle control.

In terms of the broadband light generator 10, the spectral broadening device 130 may be replaced by the spectral broadening device 230, . . . , or 730.

Spectral broadening may perform more than once. In an embodiment, one broadband light generator may comprise one or more spectral broadening devices (e.g., 130, . . . , or 730). The spectral broadening devices in one broadband light generator may be the same or different.

In an embodiment, one spectral broadening device may be divided into more than one zone. The size of a zone or the number of zones may be adjusted according to different consideration.

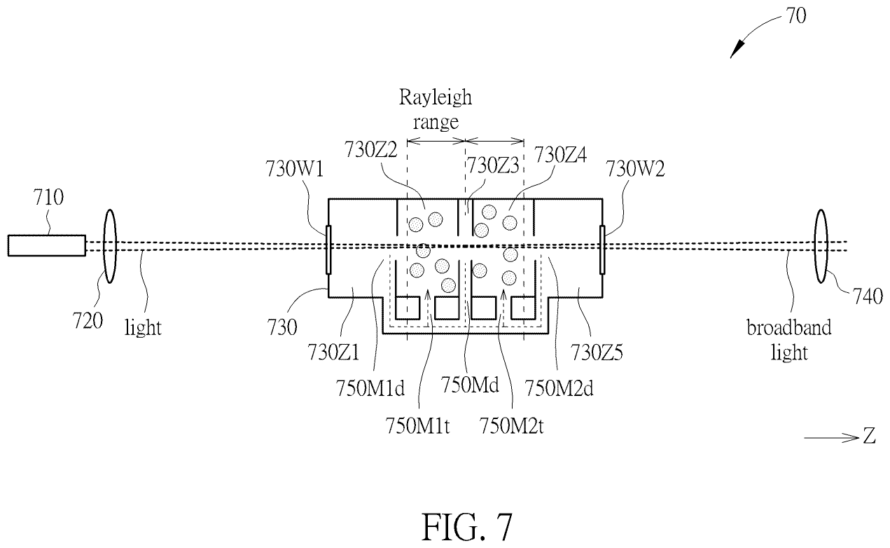

Different technical features described in the following embodiments (e.g., the different zones) may be mixed or combined in various ways if they are not conflict to each other. For example, FIG. 7 is a schematic diagram of a cross-section view of a broadband light generator 70 according to an embodiment of the present invention. The broadband light generator 70 comprises a light source 710, a focusing component 720, a spectral broadening device 730, a re-collimation component 740, and non-solid substance movers 750M1t, 750M2t, 750Md, 750Md1, 750Md2. The spectral broadening device 730, which may be regarded as a combination of the spectral broadening devices 430 and 530, is classified into zones 730Z1 to 730Z5. The zones 730Z1-730Z5 may be implemented as the zones 430Z1, 430Z2 (or 530Z2), 530Z3, 530Z4, 430Z5, respectively. The non-solid substance movers 750M1t, 750M2t, 750Md, 750Md1, 750Md2 may be implemented using the non-solid substance movers 450M1t (or 550M1t), 450M2t (or 550M2t), 550Md, 450Md1, 450Md2, respectively.

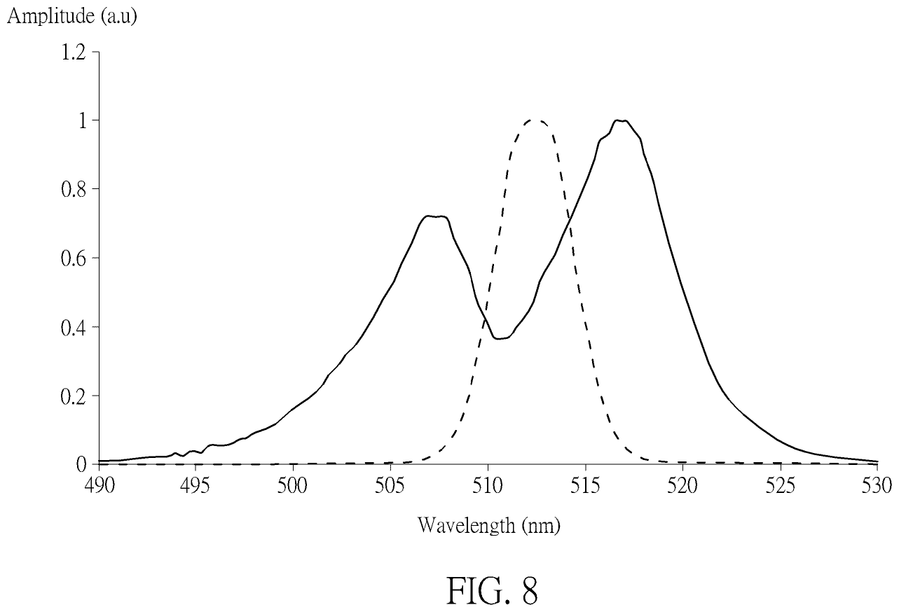

FIG. 8 is a schematic diagram of a simulation result according to an embodiment of the present invention. A bold dashed curve represents amplitude versus wavelength of the light inputted into a spectral broadening device (e.g., 130). A bold solid curve represents amplitude versus wavelength of the broadband light outputted from the spectral broadening device. As shown in FIG. 8, the spectrum of the broadband light is broader than the spectrum of the light.

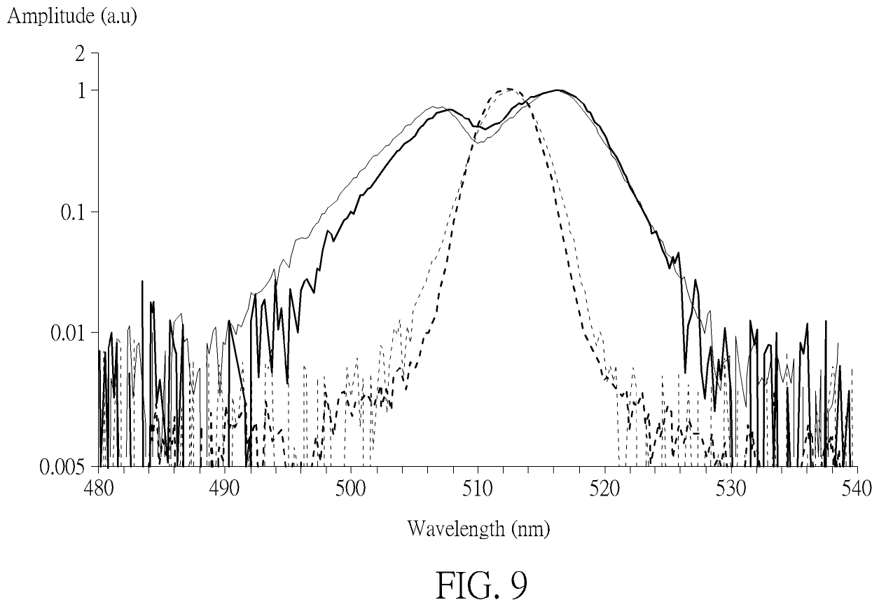

FIG. 9 is a schematic diagram of a simulation result according to an embodiment of the present invention. In FIG. 9, the non-solid substance in the spectral broadening effective range (e.g., the zone 330Z2) is Krypton (Kr). The length of the spectral broadening effective range (e.g., the zone 330Z2) is about 30 cm or about five times the Rayleigh range. The plate (e.g., 330P1 or 330P2), made of Sapphire, has a thickness of about 200 um. The focal length of the focusing component (e.g., 320) is about 1200 mm (i.e., f1200). The center frequency of the light or the broadband light is about 515 nm, but is not limited thereto and may be 1030 nm.

A bold dashed curve represents amplitude versus wavelength of the light inputted into a spectral broadening device (e.g., 330). A bold solid curve represents amplitude versus wavelength of the broadband light outputted from the spectral broadening device, wherein the degree of spectral broadening (i.e., the shortest pulse or the minimum possible duration for a given spectral bandwidth) is 30 femtosecond (fs), and the pressure in the spectral broadening effective range (e.g., the zone 330Z2) is about 900 torr. A thin solid curve represents amplitude versus wavelength of the broadband light outputted from the spectral broadening device, wherein the spectral broadening device (e.g., 330) emits a sequence of light pulses with the pulse duration of 27 fs, and the pressure in the spectral broadening effective range (e.g., the zone 330Z2) is about 1000 torr. A thin dashed curve represents amplitude versus wavelength of light spectrally broadened by plate(s) in a vacuum. As shown in FIG. 9, the spectrum of the broadband light is broader than the spectrum of the light.

Use of ordinal terms such as “first” and “second” does not by itself connote any priority, precedence, or order of one element over another, the chronological sequence in which acts of a method are performed, or the necessity for all the elements to be exist at the same time, but are used merely as labels to distinguish one element having a certain name from another element having the same name.

To sum up, the present invention uses gas/liquid zone broadening, to improve throughput lifetime. The different zones corresponding to different nonlinear refractive indices in one spectral broadening device achieve an uneven nonlinear refractive index distribution. The present invention restricts the gas/liquid distribution, to allow manipulation of the location where spectral broadening occurs in a Gaussian beam, thereby ensuring beam quality. The spectral broadening device of the present invention is one-piece design without a waveguide, and provides an easy alignment non-solid substance distributing function for gas/liquid medium spectral broadening.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A broadband light generator, comprising:
a light source, configured to emit light; and
a spectral broadening device, optically coupled to the light source, wherein a nonlinear refractive index distribution of non-solid substance within the spectral broadening device is uneven along an optical path.

2. The broadband light generator of claim 1, wherein the spectral broadening device is classified into at least one first zone and at least one second zone, and a nonlinear refractive index of the non-solid substance in the at least one second zone is higher than a nonlinear refractive index of the non-solid substance in the at least one first zone.

3. The broadband light generator of claim 2, wherein a total length of the at least one second zone is more than twice Rayleigh range or less than ten times Rayleigh range.

4. The broadband light generator of claim 2, wherein one of the at least one first zone is disposed between two of the at least one second zone, and a length of the first zone is less than twice Rayleigh range.

5. The broadband light generator of claim 1, wherein the non-solid substance comprises a first non-solid substance, a second non-solid substance, and a third non-solid substance, and the spectral broadening device comprises:
a first sub-chamber, configured to hold the first non-solid substance;
a second sub-chamber, configured to hold the second non-solid substance; and
a third sub-chamber, configured to hold the third non-solid substance, wherein the second sub-chamber is disposed between the first sub-chamber and the third sub-chamber;
wherein a nonlinear refractive index of the second non-solid substance is higher than a nonlinear refractive index of the first non-solid substance and a nonlinear refractive index of the third non-solid substance.

6. The broadband light generator of claim 5, wherein the nonlinear refractive index of the first non-solid substance is identical to the nonlinear refractive index of the third non-solid substance, or the first non-solid substance is identical to the third non-solid substance.

7. The broadband light generator of claim 5, wherein the first sub-chamber and the second sub-chamber are partitioned by a plate, and an angle between the plate and the light is a function of the nonlinear refractive index of the first non-solid substance and the nonlinear refractive index of the second non-solid substance.

8. The broadband light generator of claim 1, further comprising:
at least one non-solid substance mover, disposed inside the spectral broadening device or external to the spectral broadening device, wherein the at least one non-solid substance mover is configured to adjust density distribution or pressure distribution of the non-solid substance.

9. The broadband light generator of claim 8, wherein the spectral broadening device is classified into at least one first zone and at least one second zone, one of the at least one non-solid substance mover is configured to move the non-solid substance from one of the at least one first zone to one of the at least one second zone, wherein the first zone is located between the light source and the second zone, or between the second zone and another of the at least one second zone, and one of the at least one non-solid substance mover is a pump, a blower, a cooler, or a heater.

10. The broadband light generator of claim 1, further comprising:
a focusing component, configured to determine Rayleigh range, disposed within the spectral broadening device or between the light source and the spectral broadening device; and
a re-collimation component, disposed within the spectral broadening device or optically coupled to the spectral broadening device, wherein the focusing component or the re-collimation component comprise a lens,
wherein a cross section of the spectral broadening device is wider than a diameter of an optical fiber or a waveguide.

11. The broadband light generator of claim 1, wherein the non-solid substance is single atom or symmetrical molecule structure.

12. A broadband light generating method, comprising:
emitting light; and
directing the light into a spectral broadening device, wherein a nonlinear refractive index distribution of non-solid substance within the spectral broadening device is uneven along an optical path.

13. The broadband light generating method of claim 12, wherein the spectral broadening device is classified into at least one first zone and at least one second zone, and a nonlinear refractive index of the non-solid substance in the at least one second zone is higher than a nonlinear refractive index of the non-solid substance in the at least one first zone.

14. The broadband light generating method of claim 13, wherein a total length of the at least one second zone is more than twice Rayleigh range or less than ten times Rayleigh range.

15. The broadband light generating method of claim 13, wherein one of the at least one first zone is disposed between two of the at least one second zone, and a length of the first zone is less than twice Rayleigh range.

16. The broadband light generating method of claim 12, wherein the non-solid substance comprises a first non-solid substance, a second non-solid substance, and a third non-solid substance, and the spectral broadening device comprises:
a first sub-chamber, configured to hold the first non-solid substance;
a second sub-chamber, configured to hold the second non-solid substance; and
a third sub-chamber, configured to hold the third non-solid substance, wherein the second sub-chamber is disposed between the first sub-chamber and the third sub-chamber;
wherein a nonlinear refractive index of the second non-solid substance is higher than a nonlinear refractive index of the first non-solid substance and a nonlinear refractive index of the third non-solid substance.

17. The broadband light generating method of claim 16, wherein the nonlinear refractive index of the first non-solid substance is identical to the nonlinear refractive index of the third non-solid substance, or the first non-solid substance is identical to the third non-solid substance.

18. The broadband light generating method of claim 16, wherein the first sub-chamber and the second sub-chamber are partitioned by a plate, and an angle between the plate and the light is a function of the nonlinear refractive index of the first non-solid substance and the nonlinear refractive index of the second non-solid substance.

19. The broadband light generating method of claim 12, further comprising:
adjusting density distribution or pressure distribution of the non-solid substance by at least one non-solid substance mover, wherein the at least one non-solid substance mover is disposed inside the spectral broadening device or external to the spectral broadening device.

20. The broadband light generating method of claim 19, wherein the spectral broadening device is classified into at least one first zone and at least one second zone, one of the at least one non-solid substance mover is configured to move the non-solid substance from one of the at least one first zone to one of the at least one second zone, wherein the first zone is located between the light source and the second zone, or between the second zone and another of the at least one second zone, and one of the at least one non-solid substance mover is a pump, a blower, a cooler, or a heater.

21. The broadband light generating method of claim 12, wherein a focusing component configured to determine Rayleigh range is disposed within the spectral broadening device or between the light source and the spectral broadening device, a re-collimation component is disposed within the spectral broadening device or optically coupled to the spectral broadening device, the focusing component or the re-collimation component comprise a lens, and a cross section of the spectral broadening device is wider than a diameter of an optical fiber or a waveguide.
